(19) United States
(12) Patent Application Publication
(10) Pub. No.: US 2008/0107256 A1
(43) Pub. Date: May 8, 2008

(54) VIRTUAL CONTACT CENTER

(75) Inventors: PEEYUSH JAISWAL, Boca Raton, FL (US); NAVEEN NARAYAN, Flower Mound, TX (US); Fang Wang, Plano, TX (US)

Correspondence Address: DILLON & YUDELL LLP, 8911 N. CAPITAL OF TEXAS HWY.,, SUITE 2110, AUSTIN, TX, 78759, US

(73) Assignee: INTERNATIONAL BUSINESS MACHINES CORPORATION, Armonk, NY (US)

(21) Appl. No.: 11/557,538

(22) Filed: Nov. 8, 2006

(51) Int. Cl. H04M 3/00

(52) U.S. Cl. 379/265.12

(57) ABSTRACT

A method, system and computer-readable medium for providing a Virtual Contact Center (VCC) to call-in customers is presented. In a preferred embodiment, the method includes the steps of: screening a plurality of service agents according to agent qualifications needed by a Virtual Contact Center (VCC); developing a network of pre-qualified service agents from the screening step, wherein each pre-qualified service agent is an independent contractor; receiving, at a Virtual Contact Center Portal (VCCP), a request for service call from a customer; and directing the request for service call through the VCCP to one of the pre-qualified service agents according to a nature of the request for service call.

### BACKGROUND OF THE INVENTION

1. Technical Field

The present invention relates in general to the field of computers, and more particularly to the use of computers utilized by call centers. Still more particularly, the present invention relates to a portal system used with a virtual contact center.

2. Description of the Related Art

Contact centers are a central point in an enterprise from which customer contacts are managed. These customer contacts are usually telephone call requesting service, such as technical service support for products bought or leased from the enterprise. In a traditional contact center, all telephone calls, to the contact center, are handled by employees of the enterprise. For example, FIG. 1 depicts a contact center customer 102 placing a telephone call to an enterprise contact center 104. This telephone call is handled by a call router 106, which may be a switchboard operator, or more likely, an automated call router that uses some type of keypad or voice activated menu for directing the call to the appropriate department 108a-c or enterprise employee 110a-c. Thus, all resources (departments 108 and enterprise employees 110) are directly managed, owned and employed by a single enterprise.

A major drawback to an enterprise contact center 104, as depicted in FIG. 1, is the lack of scalability. That is, the enterprise must employ a fixed number of employees, who may be overtaxed or underutilized, depending on the incoming call volume. The use of temporary employees is a human resources nightmare.

### SUMMARY OF THE INVENTION

To address the problem described above, the present invention provides for a method, system and computer-readable medium for providing a Virtual Contact Center (VCC) to call-in customers. In a preferred embodiment, the method includes the steps of: screening a plurality of service agents according to agent qualifications needed by a Virtual Contact Center (VCC); developing a network of pre-qualified service agents from the screening step, wherein each pre-qualified service agent is an independent contractor; receiving, at a Virtual Contact Center Portal (VCCP), a request for service call from a customer; and directing the request for service call through the VCCP to one of the pre-qualified service agents according to a nature of the request for service call.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts a prior art enterprise call center having departments and enterprise employees that are dedicated to providing contact center service for a single enterprise;

FIG. 2A graphically illustrates relationships among a global agent workforce, a virtual contact center portal, and contact center customers;

FIG. 2B illustrates an exemplary User Interfaces (UI) that is used to pre-qualify a global agent;

FIG. 2C depicts an exemplary UI used by a calling customer to determine which pre-qualified agent should take the customer's call;

FIG. 3 illustrates an exemplary client and server computer in which the present invention may be utilized;

FIG. 4 is a flow-chart of exemplary steps taken by the present invention to simulate and evaluate a service process utilizing the VCCP;

FIGS. 5A-B are flow-charts showing steps taken to deploy software capable of executing the steps described in FIG. 4; and

FIGS. 6A-B are flow-charts showing steps taken to execute the steps shown in FIG. 4 using an on-demand service provider.

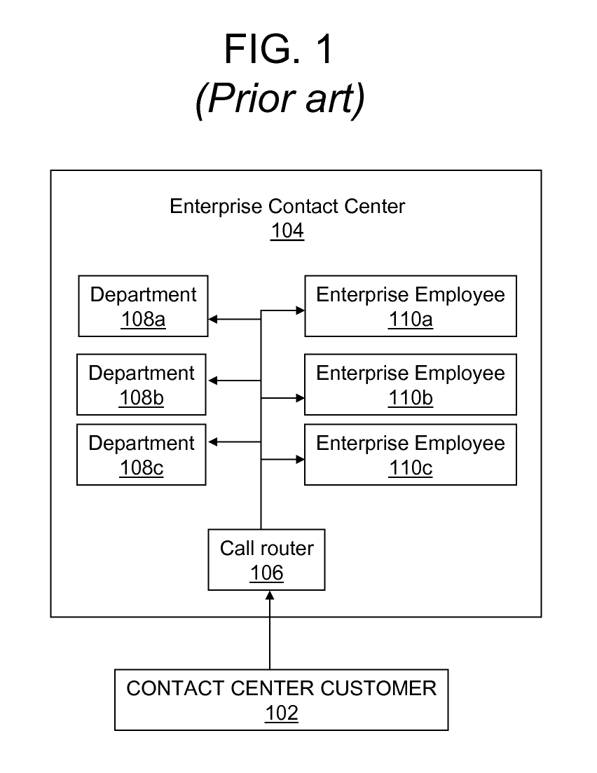

### DETAILED DESCRIPTION OF THE PREFERRED EMBODIMENT

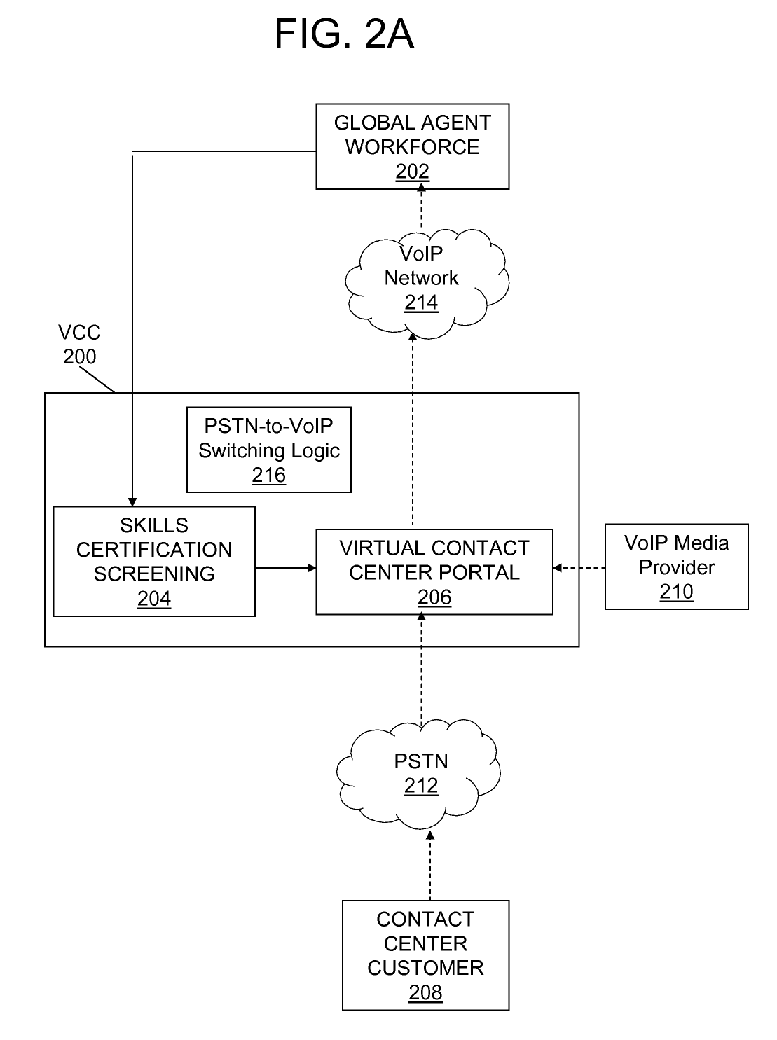

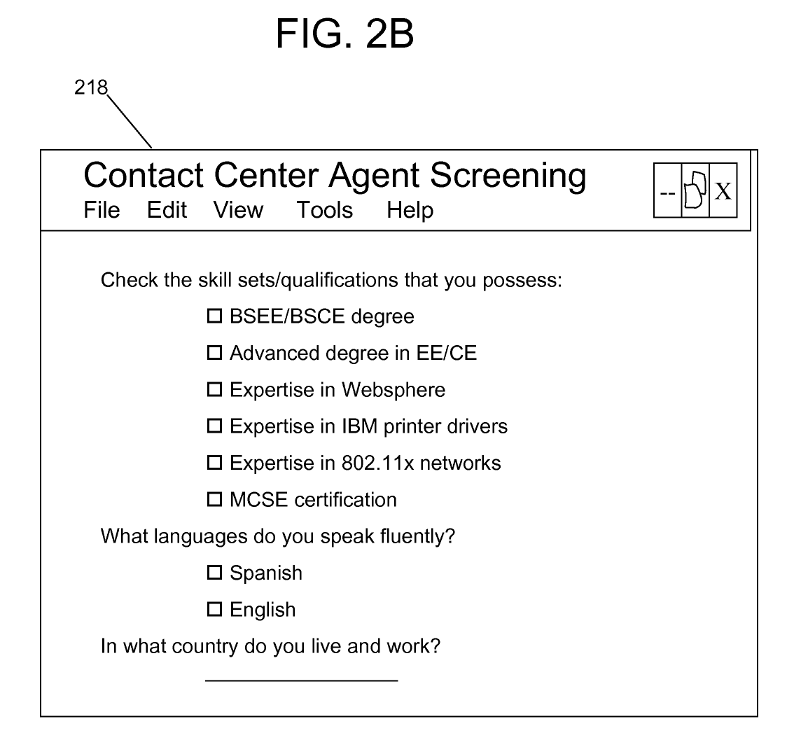

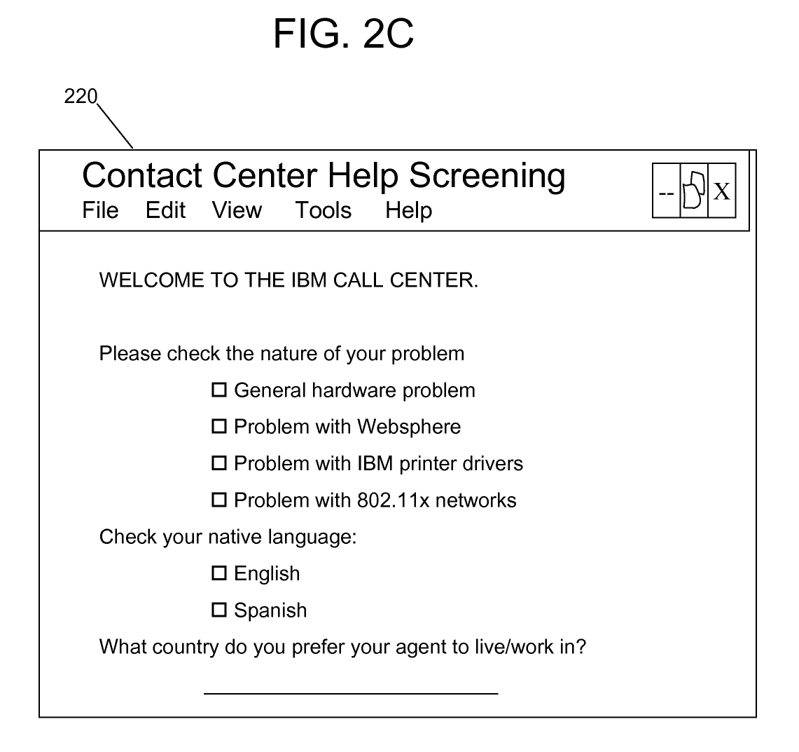

With reference now to FIG. 2A, a high-level overview of the architecture of a novel Virtual Contact Center (VCC) 200 is presented. Global agent workforce 202 includes agents that are physically located worldwide, do not work at a single enterprise's worksite, and are not limited to servicing local call-in customers. Rather, because of their global nature, the agents in global agent workforce 202 can provide, to a customer in a foreign country, specialized service, which is superior due to a particular agent's expertise, proximity to a manufacturing site, language skill, etc. As will be described in further detail below, each agent in the global agent workforce 202 is an independent contractor. That is, each agent independently contracts his service to VCC 200. Since VCC 200 provides call-in service to multiple enterprises, then each agent is able to field calls for the multiple enterprises.

Access to the global agent workforce 202 is provided via a Virtual Contact Center Portal (VCCP) 206. VCCP 206 is a web portal designed to provide service tailored to each contact center customer 208. That is, in a manner such as described below, each contact center customer 208 enters the VCCP 206, and is directed from there to an appropriate pre-certified agent from the global agent workforce 202. While described in exemplary manner as a website, VCCP 206 may alternatively be a traditional call-in router that uses an Interactive Voice Response (IVR) system, which directs the contact center customer's call to the appropriate agent through a series of audio questions and their voice responses. Note that VCCP 206 also supports a link to a VoIP Media Provider 210, which allows the contact center customer 208 to seamlessly transition from a standard Public Switched Telephone Network (PSTN) 212 (or a cellular phone network—not shown) to a VoIP network 214 through the use of a PSTN-to-VoIP switching logic 216. That is, when the call arrives at the VCC 200, the caller is likely to be on a land-line system, which, if long distance, results in a charge to the caller or to the VCC 200 (if the call is a toll-free “800” number). The PSTN-to-VoIP switching logic 216 captures the incoming call, disconnects the PSTN 212 connection, and continues the call (to the agent in the global agent workforce 202), via a VoIP network 214 that is provided by VoIP media provider 210. Thus, the caller can call anywhere in the world for a fixed low-cost fee offered by the VoIP media provider 210. Alternatively, the VoIP connection can be between only the VCC 200 and the agent in global agent workforce 202, while the PSTN connection between the VCC 200 and the contact center customer 208 remains intact.

As indicated in FIG. 2A, each agent from the global agent workforce 202 must first go through a skills certification screening 204 before VCCP 206 directs calls to that agent. An exemplary User Interface (UI) 218, provided by VCCP 206, is shown in FIG. 2B. Note the general nature of the questions, which may be applicable to qualifications needed to field questions directed to multiple enterprises that are supported by VCC 200. For example, the question about the agent's expertise in Websphere® is significant to IBM® customers, while the question about the agent's Microsoft Certified Systems Engineer (MCSE) certification is more appropriate for determining if the agent can handle a question directed to a Microsoft® product. Note also the questions regarding what languages the agent speaks and where she lives/works. The language question relates to overcoming any language barrier that a caller may present. The question regarding where the agent lives/works has two significant uses. First, by living in a particular foreign country, local idioms used by the caller may or may not be understood by the agent, and vice versa. Therefore, the caller and agent should be matched according to where the caller lives/works. Second, unless the agent otherwise indicates, in another questionnaire (not shown), a non-standard work schedule (i.e., nighttime), then the question avoids the problem of routing a service call to an agent who is normally asleep at the time of the call.

As shown in FIG. 2C, a UI 220, used by the caller to set up a service call, is asked questions that correspond with those asked of the agent. For example, if the caller has a problem with Websphere®, then VCCP 206 would match up that caller with an agent having expertise in this IBM® product. Similarly, if the caller prefers an English speaking agent in the United States, then the caller would be matched up with an agent meeting those criteria.

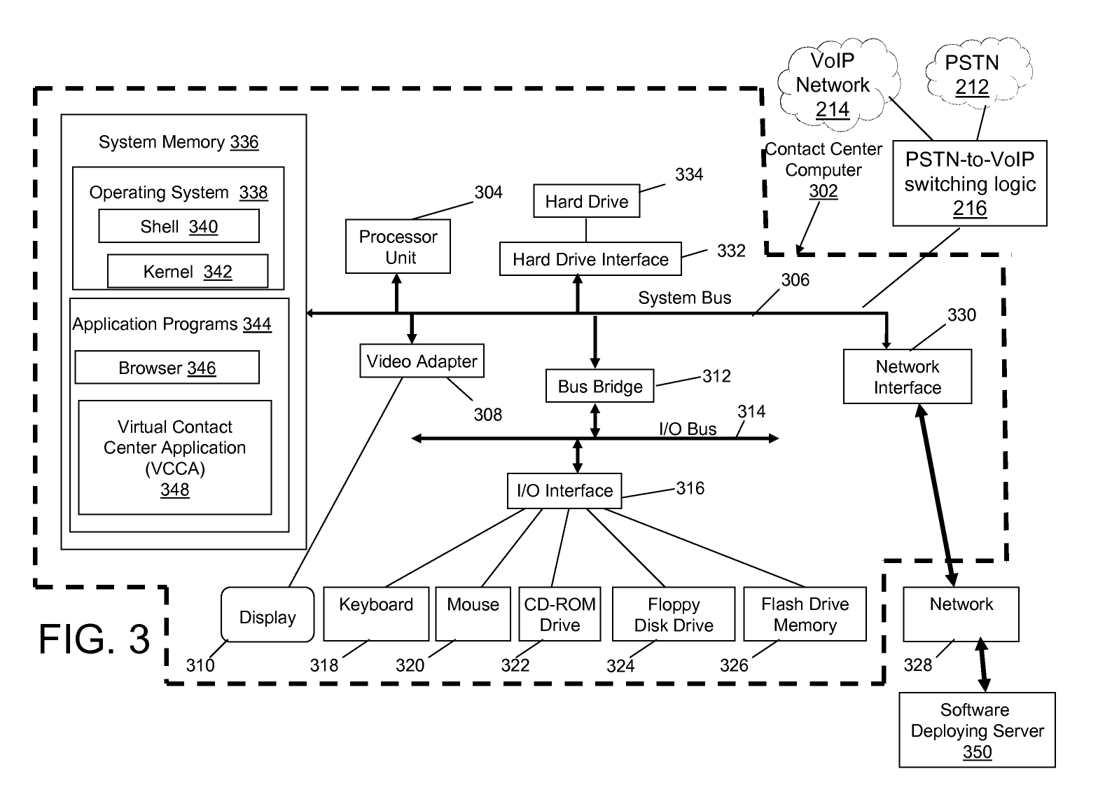

With reference now to FIG. 3, there is depicted a block diagram of an exemplary contact center computer 302, in which the present invention may be utilized. Contact center computer 302 includes a processor unit 304 that is coupled to a system bus 306. A video adapter 308, which drives/supports a display 310, is also coupled to system bus 306. System bus 306 is coupled via a bus bridge 312 to an Input/Output (I/O) bus 314. An I/O interface 316 is coupled to I/O bus 314. I/O interface 316 affords communication with various I/O devices, including a keyboard 318, a mouse 320, a Compact Disk-Read Only Memory (CD-ROM) drive 322, a floppy disk drive 324, and a flash drive memory 326. The format of the ports connected to I/0 interface 316 may be any known to those skilled in the art of computer architecture, including but not limited to Universal Serial Bus (USB) ports.

Contact center computer 302 is able to communicate with a software deploying server 350 via a network 328 using a network interface 330, which is coupled to system bus 306. Network 328 may be an external network such as the Internet, or an internal network such as an Ethernet or a Virtual Private Network (VPN). Note the software deploying server 350 may utilize a same or substantially similar architecture as contact center computer 302.

A hard drive interface 332 is also coupled to system bus 306. Hard drive interface 332 interfaces with a hard drive 334. In a preferred embodiment, hard drive 334 populates a system memory 336, which is also coupled to system bus 306. System memory is defined as a lowest level of volatile memory in contact center computer 302. This volatile memory includes additional higher levels of volatile memory (not shown), including, but not limited to, cache memory, registers and buffers. Data that populates system memory 336 includes contact center computer 302's operating system (OS) 338 and application programs 344.

OS 338 includes a shell 340, for providing transparent user access to resources such as application programs 344. Generally, shell 340 is a program that provides an interpreter and an interface between the user and the operating system. More specifically, shell 340 executes commands that are entered into a command line user interface or from a file. Thus, shell 340 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 342) for processing. Note that while shell 340 is a text-based, line-oriented user interface, the present invention will equally well support other user interface modes, such as graphical, voice, gestural, etc.

As depicted, OS 338 also includes kernel 342, which includes lower levels of functionality for OS 338, including providing essential services required by other parts of OS 338 and application programs 344, including memory management, process and task management, disk management, and mouse and keyboard management.

Application programs 344 include a browser 346. Browser 346 includes program modules and instructions enabling a World Wide Web (WWW) client (i.e., contact center computer 302) to send and receive network messages to the Internet using HyperText Transfer Protocol (HTTP) messaging, thus enabling communication with software deploying server 350.

Application programs 344 in contact center computer 302's system memory (as well as software deploying server 350's system memory) also include a Virtual Contact Center Application (VCCA) 348. VCCA 348 includes code for implementing the processes described in FIGS. 2A-4. In one embodiment, contact center computer 302 is able to download VCCA 348 from software deploying server 350.

The hardware elements depicted in contact center computer 302 are not intended to be exhaustive, but rather are representative to highlight essential components required by the present invention. For instance, contact center computer 302 may include alternate memory storage devices such as magnetic cassettes, Digital Versatile Disks (DVDs), Bernoulli cartridges, and the like. These and other variations are intended to be within the spirit and scope of the present invention.

Note that contact center computer 302 also incorporates the PSTN-to-VoIP switching logic 216 described in FIG. 2A. Preferably, the PSTN-to-VoIP switching logic 216 is coupled between the PSTN 212 and system bus 306, thus providing access to network interface 330 to facilitate the VoIP capabilities provided by the VoIP media provider 210 via a network 328, which network includes the capabilities of VoIP network 214. Thus, PSTN-to-VoIP switching logic 216 includes logic for switching the PSTN connection to a VoIP connection by 1) establishing a VoIP connection between the VCC 200 and the contact center customer 208; and then 2) decoupling the PSTN connection with the contact center customer 208. Alternatively, PSTN-to-VoIP switching logic can convert the voice signal from the PSTN 212 network into data packets acceptable to a VoIP protocol, leave the PSTN connection intact, and have a VoIP connection only between the VCCP 206 and the agent.

Note further that, in a preferred embodiment of the present invention, software deploying server 350 performs all of the functions associated with the present invention (including execution of VCCA 348), thus freeing contact center computer 302 from having to use its own internal computing resources to execute VCCA 348.

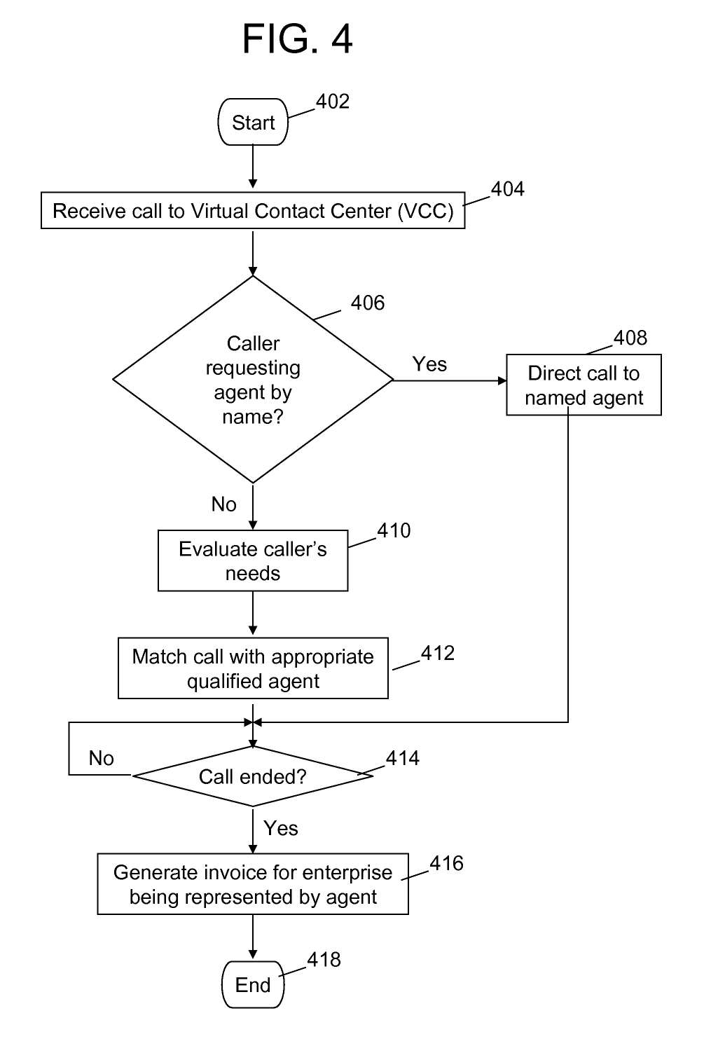

With reference now to FIG. 4, a high-level flow-chart of exemplary steps taken by the present invention is presented. After initiator block 402, a call, from a customer, is received at the Virtual Contact Center (VCC), described above as VCC 200. If the caller has called the VCC before, then she may already know which pre-certified agent she wishes to speak with, and may ask for him by name (e.g., responsive to an Interactive Voice Response—IVR query, pressing specified telephone keypad buttons in response to a menu directory, etc.). If so (query block 406), then the call is directed to the requested agent (block 408). Otherwise, the needs of the caller are evaluated (block 410). This evaluation can be according to inputs from inputs placed on a UI such as UI 220 described above, or by some alternate method. For example, the VCC may recognize a telephone number of the caller, and after consulting a history table of past users and the pre-certified agent that helped them in the past, direct the call to the agent who helped a caller from that telephone number in the past. Alternatively, the caller's needs can be narrowed down through the use of an IVR or phone menu query, and the call is then directed to the appropriate agent based on the caller's responses.

Once the caller's needs have been properly evaluated, the caller is matched with an appropriate pre-certified agent (block 412). The pre-certified agent then handles the call, preferably over a VoIP network as described above, until it is ended (query block 414). Once the call is ended, an invoice entry is generated for the enterprise whose interests have been represented by the pre-certified agent (block 416). For example, if the pre-certified agent handled a question concerning an IBM® product, then an invoice entry for that pre-certified agent is registered with the VCC. The VCC thus includes bookkeeping logic, preferably as part of VCCA 348 described in FIG. 3, which not only keeps a tally of how much is owed to each pre-certified agent (who are all independent contractors), but also how much to bill the enterprise being aided by the pre-certified agent. The process thus ends at terminator block 418.

It should be understood that at least some aspects of the present invention may alternatively be implemented in a computer-readable medium that contains a program product. Programs defining functions on the present invention can be delivered to a data storage system or a computer system via a variety of tangible signal-bearing media, which include, without limitation, non-writable storage media (e.g., CD-ROM), writable storage media (e.g., hard disk drive, read/write CD ROM, optical media), as well as non-tangible communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

### Software Deployment

As described above, in one embodiment, the processes described by the present invention, including the functions of VCCA 348, are performed by service provider server 350. Alternatively, VCCA 348 and the method described herein, and in particular as shown and described in FIGS. 2A-4, can be deployed as a process software from service provider server 350 to contact center computer 302. Still more particularly, process software for the method so described may be deployed to service provider server 350 by another service provider server (not shown).

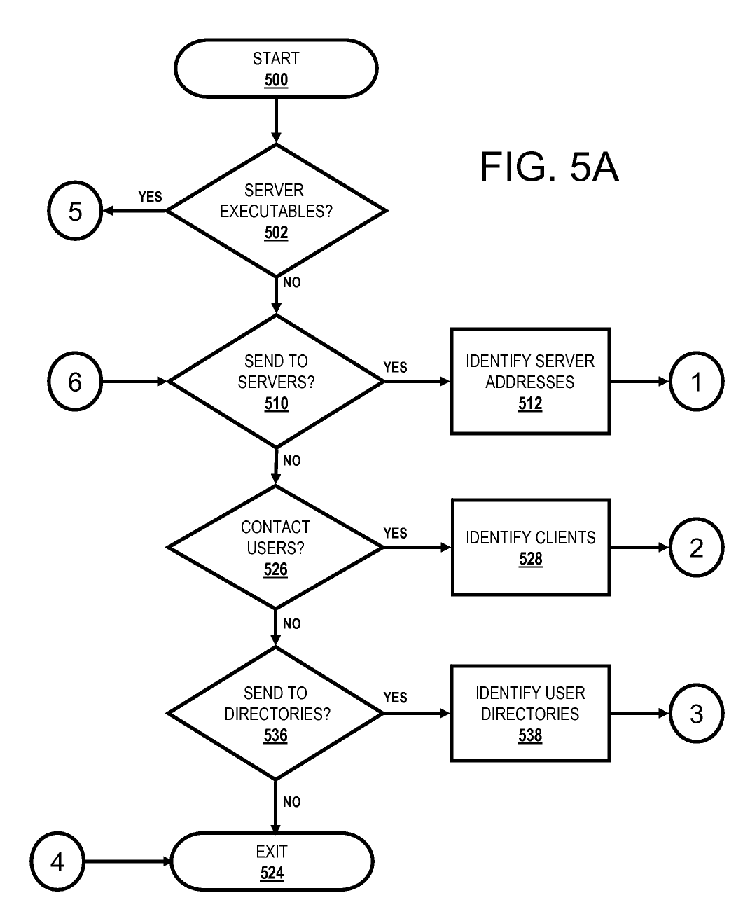

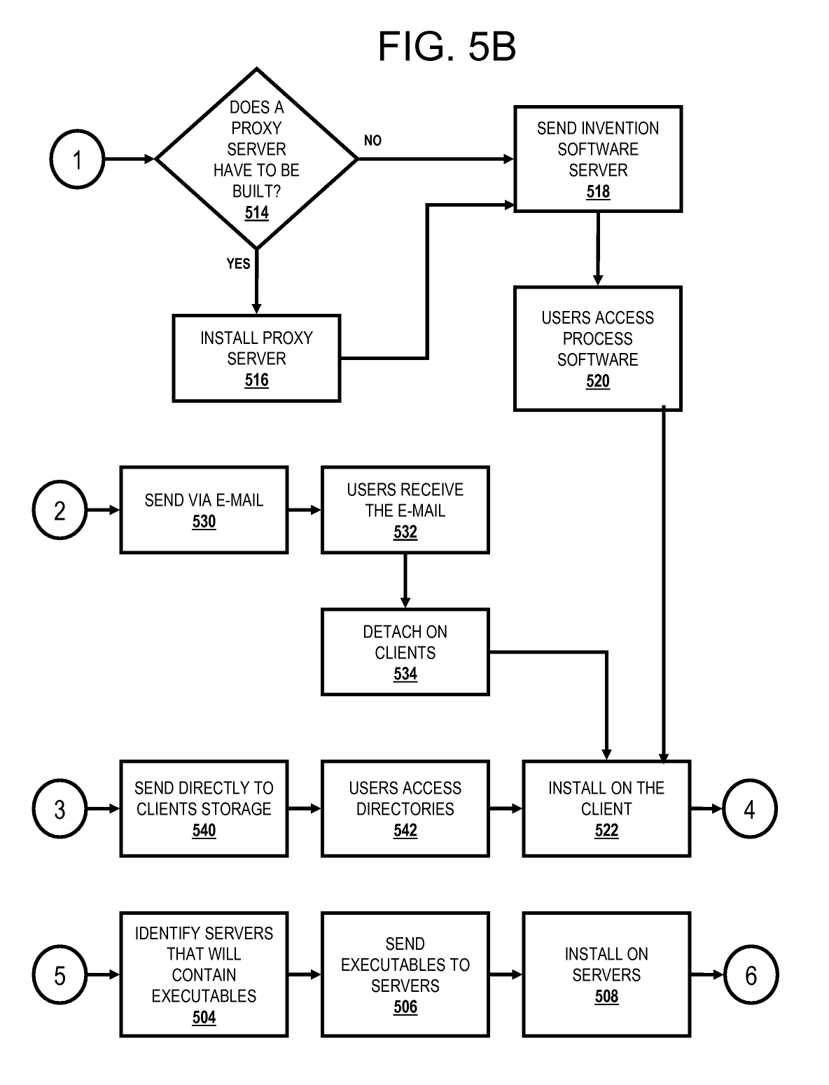

Referring then to FIGS. 5A-B, step 500 begins the deployment of the process software. The first thing is to determine if there are any programs that will reside on a server or servers when the process software is executed (query block 502). If this is the case, then the servers that will contain the executables are identified (block 504). The process software for the server or servers is transferred directly to the servers' storage via File Transfer Protocol (FTP) or some other protocol or by copying though the use of a shared file system (block 506). The process software is then installed on the servers (block 508).

Next, a determination is made on whether the process software is to be deployed by having users access the process software on a server or servers (query block 510). If the users are to access the process software on servers, then the server addresses that will store the process software are identified (block 512).

A determination is made if a proxy server is to be built (query block 514) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 516). The process software is sent to the servers either via a protocol such as FTP or it is copied directly from the source files to the server files via file sharing (block 518). Another embodiment would be to send a transaction to the servers that contained the process software and have the server process the transaction, then receive and copy the process software to the server's file system. Once the process software is stored at the servers, the users via their contact center computers, then access the process software on the servers and copy to their contact center computers file systems (block 520). Another embodiment is to have the servers automatically copy the process software to each client and then run the installation program for the process software at each contact center computer. The user executes the program that installs the process software on his contact center computer (block 522) then exits the process (terminator block 524).

In query step 526, a determination is made whether the process software is to be deployed by sending the process software to users via e-mail. The set of users where the process software will be deployed are identified together with the addresses of the user contact center computers (block 528). The process software is sent via e-mail to each of the users' contact center computers (block 530). The users then receive the e-mail (block 532) and then detach the process software from the e-mail to a directory on their contact center computers (block 534). The user executes the program that installs the process software on his contact center computer (block 522) then exits the process (terminator block 524).

Lastly a determination is made as to whether the process software will be sent directly to user directories on their contact center computers (query block 536). If so, the user directories are identified (block 538). The process software is transferred directly to the user's contact center computer directory (block 540). This can be done in several ways such as but not limited to sharing of the file system directories and then copying from the sender's file system to the recipient user's file system or alternatively using a transfer protocol such as File Transfer Protocol (FTP). The users access the directories on their client file systems in preparation for installing the process software (block 542). The user executes the program that installs the process software on his contact center computer (block 522) and then exits the process (terminator block 524).

### VPN Deployment

The present software can be deployed to third parties as part of a service wherein a third party VPN service is offered as a secure deployment vehicle or wherein a VPN is build on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-free number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called runnel interfaces, where the packet enters and exits the network.

### Software Integration

The process software which consists code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists match the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

### On Demand

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory utilization, storage utilization, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory utilization, storage utilization, etc. approach a capacity so as to affect performance, additional network bandwidth, memory utilization, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

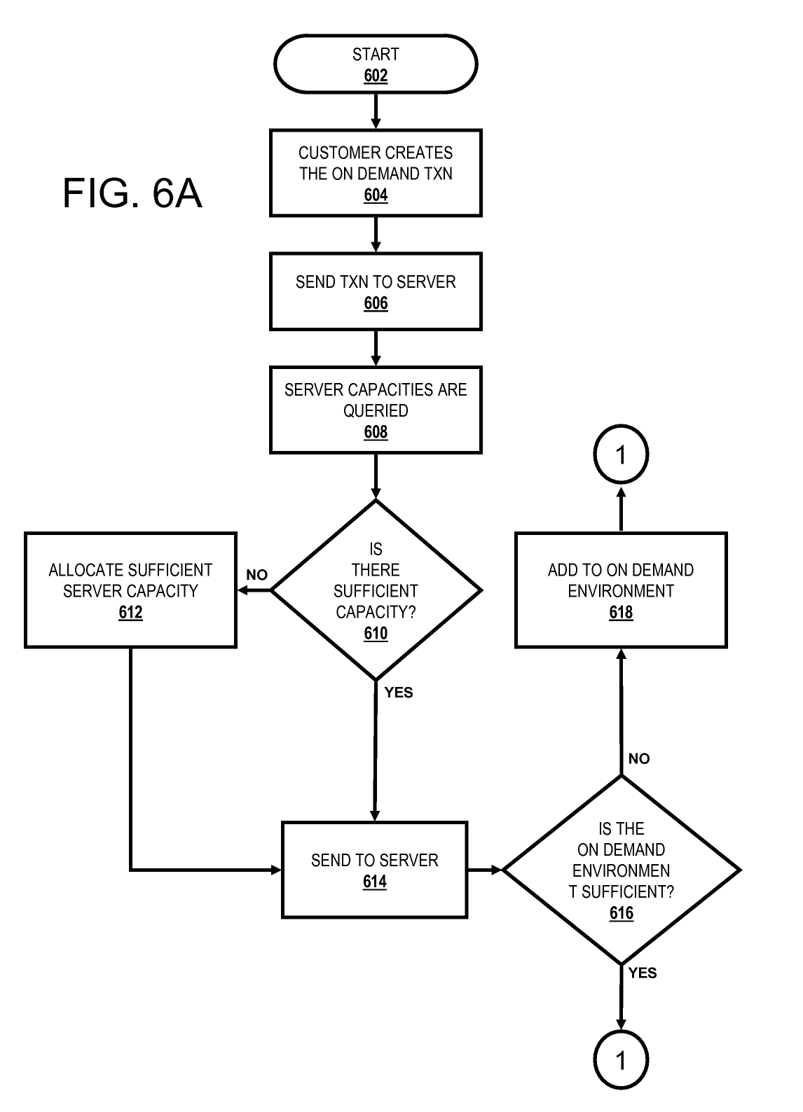

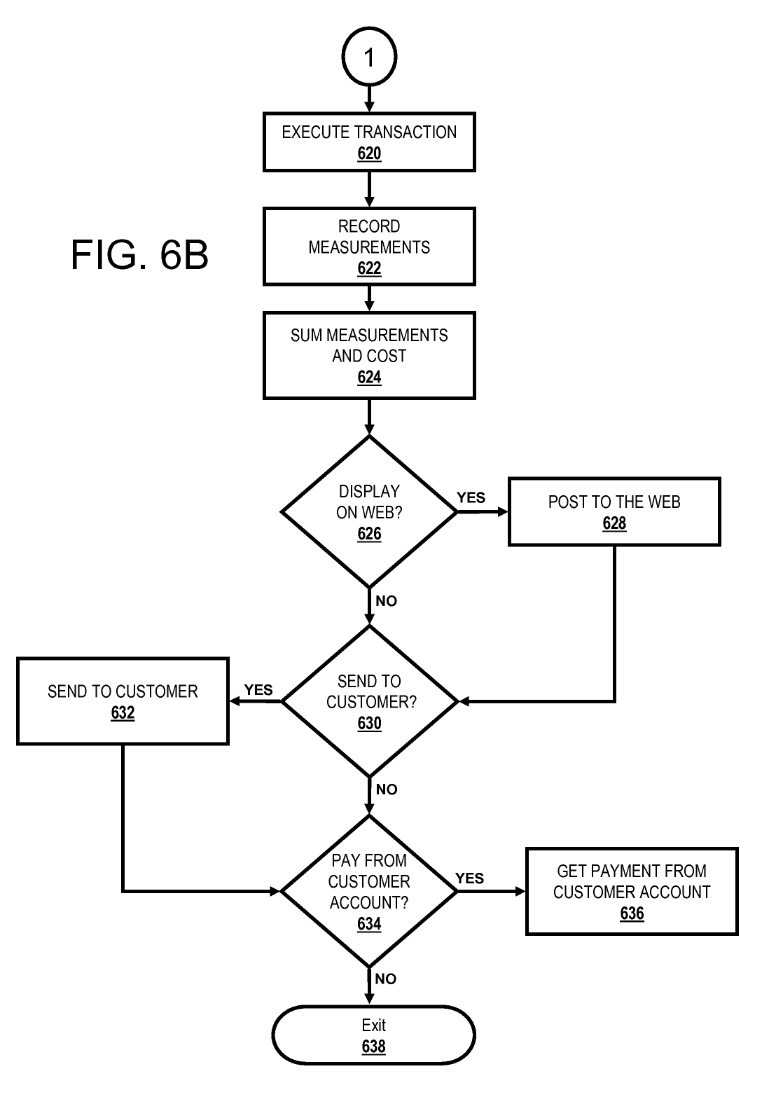

With reference now to FIGS. 6a-b, initiator block 602 begins the On Demand process. A transaction is created than contains the unique customer identification, the requested service type and any service parameters that further, specify the type of service (block 604). The transaction is then sent to the main server (block 606). In an On Demand environment the main server can initially be the only server, then as capacity is consumed other servers are added to the On Demand environment.

The server central processing unit (CPU) capacities in the On Demand environment are queried (block 608). The CPU requirement of the transaction is estimated, then the servers available CPU capacity in the On Demand environment are compared to the transaction CPU requirement to see if there is sufficient CPU available capacity in any server to process the transaction (query block 610). If there is not sufficient server CPU available capacity, then additional server CPU capacity is allocated to process the transaction (block 612). If there was already sufficient Available CPU capacity then the transaction is sent to a selected server (block 614).

Before executing the transaction, a check is made of the remaining On Demand environment to determine if the environment has sufficient available capacity for processing the transaction. This environment capacity consists of such things as but not limited to network bandwidth, processor memory, storage etc. (block 616). If there is not sufficient available capacity, then capacity will be added to the On Demand environment (block 618). Next the required software to process the transaction is accessed, loaded into memory, then the transaction is executed (block 620).

The usage measurements are recorded (block 622). The utilization measurements consist of the portions of those functions in the On Demand environment that are used to process the transaction. The usage of such functions as, but not limited to, network bandwidth, processor memory, storage and CPU cycles are what is recorded. The usage measurements are summed, multiplied by unit costs and then recorded as a charge to the requesting customer (block 624).

If the customer has requested that the On Demand costs be posted to a web site (query block 626), then they are posted (block 628). If the customer has requested that the On Demand costs be sent via e-mail to a customer address (query block 630), then these costs are sent to the customer (block 632). If the customer has requested that the On Demand costs be paid directly from a customer account (query block 634), then payment is received directly from the customer account (block 636). The On Demand process is then exited at terminator block 638.

As described herein, the present invention thus provides for a method, system and computer-readable medium for providing a Virtual Contact Center (VCC) to call-in customers. In a preferred embodiment, the method includes the steps of: screening a plurality of service agents according to agent qualifications needed by a Virtual Contact Center (VCC); developing a network of pre-qualified service agents from the screening step, wherein each pre-qualified service agent is an independent contractor; receiving, at a Virtual Contact Center Portal (VCCP), a request for service call from a customer; and directing the request for service call through the VCCP to one of the pre-qualified service agents according to a nature of the request for service call.

In one embodiment, the VCCP directs request for service calls for multiple enterprises, which have different owners, such that a same pre-qualified service agent is authorized, by the VCCP, to field calls placed to the multiple enterprises. Upon completion of the call service provided by the pre-qualified service agent, an invoice may be generated for at least one of the multiple enterprises according to service provided, by the pre-qualified service agent, on behalf of the at least one of the multiple enterprises. The screening of the service agent may be performed via an on-line questionnaire from the VCC. Furthermore, the nature of the request for service call may be determined by customer responses to an Interactive Voice Response (IVR) system in the VCCP.

In another embodiment, the request for service call is from a customer speaking a foreign language, and the request for service call is directed to a pre-qualified service agent who is physically located in a foreign country in which the foreign language is primarily spoken by indigenous residents of the foreign country.

In another embodiment, the method includes the step of publishing an on-line advertisement, for a specific pre-qualified service agent, on a portal webpage of the VCCP, wherein the advertisement describes technical skill sets of the specific pre-qualified service agent.

In another embodiment, the method includes the step of converting a Public Switched Telephone Network (PSTN) signal between the customer and the VCC to a Voice over Internet Protocol (VoIP) data packet, wherein the request for service call between the customer and the pre-qualified service agent is over a VoIP network.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A method for providing service via a Virtual Contact Center (VCC), the method comprising:
screening a plurality of service agents according to agent qualifications needed by a Virtual Contact Center (VCC);
developing a network of pre-qualified service agents from the screening step, wherein each pre-qualified service agent is an independent contractor;
receiving, at a Virtual Contact Center Portal (VCCP), a request for service call from a customer; and
directing the request for service call through the VCCP to one of the pre-qualified service agents according to a nature of the request for service call.

2. The method of claim 1, wherein the VCCP directs request for service calls for multiple enterprises.

3. The method of claim 2, wherein the multiple enterprises each have different owners.

4. The method of claim 3, wherein a same pre-qualified service agent is authorized, by the VCCP, to field calls placed to the multiple enterprises.

5. The method of claim 4, further comprising:
generating an invoice for at least one of the multiple enterprises according to service provided, by the pre-qualified service agent, on behalf of the at least one of the multiple enterprises.

6. The method of claim 1, further comprising:
converting a Public Switched Telephone Network (PSTN) signal between the customer and the VCC to a Voice Over Internet Protocol (VoIP) data packet, wherein the request for service call between the customer and the pre-qualified service agent is over a VoIP network.

7. The method of claim 1, wherein the nature of the request for service call is determined by customer responses to an Interactive Voice Response (IVR) system in the VCCP.

8. The method of claim 1, wherein the request for service call is from a customer speaking a foreign language, and wherein the request for service call is directed to a pre-qualified service agent who is physically located in a foreign country in which the foreign language is primarily spoken by indigenous residents of the foreign country.

9. The method of claim 1, further comprising:
publishing an on-line advertisement, for a specific pre-qualified service agent, on a portal webpage of the VCCP, wherein the advertisement describes technical skill sets of the specific pre-qualified service agent.

10. A system comprising:
a processor;
a data bus coupled to the processor;
a memory coupled to the data bus; and
a computer-usable medium embodying computer program code, the computer program code comprising instructions executable by the processor and configured for:
screening a plurality of service agents according to agent qualifications needed by a Virtual Contact Center (VCC);
developing a network of pre-qualified service agents from the screening step, wherein all of the pre-qualified service agents are independent contractors;
receiving, at a Virtual Contact Center Portal (VCCP), a request for service call from a customer; and
directing the request for service call through the VCCP to one of the pre-qualified service agents according to a nature of the request for service call.

11. The system of claim 10, wherein the VCCP directs request for service calls for multiple enterprises.

12. The system of claim 11, wherein the multiple enterprises each have different owners.

13. The system of claim 12, wherein a same pre-qualified service agent is authorized, by the VCCP, to field calls placed to the multiple enterprises.

14. A computer-readable medium embodying computer program code for controlling access to a relational database, the computer program code comprising computer executable instructions configured for:
screening a plurality of service agents according to agent qualifications needed by a Virtual Contact Center (VCC);
developing a network of pre-qualified service agents from the screening step, wherein each of the pre-qualified service agents is an independent contractor;
receiving, at a Virtual Contact Center Portal (VCCP), a request for service call from a customer; and
directing the request for service call through the VCCP to one of the pre-qualified service agents according to a nature of the request for service call.

15. The computer-readable medium of claim 14, wherein the VCCP directs request for service calls for multiple enterprises.

16. The computer-readable medium of claim 15, wherein the multiple enterprises each have different owners.

17. The computer-readable medium of claim 16, wherein a same pre-qualified service agent is authorized, by the VCCP, to field calls placed to the multiple enterprises.

18. The computer-readable medium of claim 14, wherein the screening step is performed via an on-line questionnaire from the VCC.

19. The computer-readable medium of claim 14, wherein the computer-usable medium is a component of a remote server, and wherein the computer executable instructions are deployable to a contact center computer from the remote server.

20. The computer-readable medium of claim 14, wherein the computer executable instructions are capable of being provided by a service provider to a customer on an on-demand basis.
